(19) United States
(12) Patent Application Publication
(10) Pub. No.: US 2011/0145996 A1
(43) Pub. Date: Jun. 23, 2011

(54) Reversible Foam Mattress and Method of Construction

(76) Inventors: Kara Johan, Orange, CA (US); Joseph Reyes, Fontana, CA (US); Dennis Flessate, Lighthouse Point, FL (US)

(21) Appl. No.: 12/644,210

(22) Filed: Dec. 22, 2009

(51) Int. Cl. A47C 27/14; B68G 7/00

(52) U.S. Cl. 5/731; 29/91.1

(57) ABSTRACT

A reversible foam mattress is formed of a foam core and includes a comfort side on one side of the foam core, a support side on an opposite side of the foam core, and side rails formed along longitudinal edges of the foam core. The comfort side includes a first convoluted section with convolutions having a first height, and the support side includes a second convoluted section with convolutions having a second height shorter than the first height.

### CROSS-REFERENCES TO RELATED APPLICATIONS

(NOT APPLICABLE)

### STATEMENT REGARDING FEDERALLY SPONSORED RESEARCH OR DEVELOPMENT

(NOT APPLICABLE)

### BACKGROUND OF THE INVENTION

The invention relates to a foam support surface and, more particularly, to a reversible foam mattress including a comfort side and a support side.

Choice of firmness in a support surface varies from individual to individual. Some individuals prefer a soft sleeping surface, while others prefer a firm sleeping surface. Managers of residence halls would like to satisfy the varying needs of their residents by offering mattresses that can accommodate individual preferences over time.

Certain medical conditions may also require individuals to use a support surface or mattress that is better suited to accommodate the medical condition. For example, if an individual is having back problems, a more supportive mattress may be desirable. The individual may not desire to use the more supportive mattress indefinitely. In another example, the individual may be having difficulty sleeping, in which case it may be desirable for the individual to use a mattress having characteristics that are suited for comfort. In either case, it would be desirable to provide a reversible mattress with opposite sides having different supporting characteristics.

Side rails on a foam mattress are typically provided to prevent the sides of the mattress from bottoming out when an individual is sitting on an edge of the mattress. The side rails may be a thicker foam or a firmer foam or both. Typically, the side rails are glued or laminated to the main portion of the mattress, thereby adding a manufacturing step and increasing manufacturing costs.

### BRIEF SUMMARY OF THE INVENTION

In preferred embodiments, a foam core is convoluted on two sides using a convolution tool. The tool is narrower than the width of the core, thereby eliminating the need for side rail lamination. That is, the side rails are preferably formed as integral parts of the foam core by convoluting only a center portion of the core. Each side of the foam core includes convolutions of different heights such that one side has characteristics to enhance comfort, while the other side has characteristics to enhance support.

In an exemplary embodiment, a reversible foam mattress is formed of a foam core and includes a comfort side on one side of the foam core, a support side on an opposite side of the foam core, and side rails formed along longitudinal edges of the foam core. The comfort side includes a first convoluted section with convolutions having a first height, and the support side includes a second convoluted section with convolutions having a second height shorter than the first height. Preferably, the first height is between 0.6 and 0.75 inches, more preferably about 0.65 inches, and the second height is between 0.25 and 0.5 inches, more preferably about 0.45 inches.

The side rails may be integral with the foam core. In one arrangement, the side rails have substantially flat surfaces across a width thereof. The flat surfaces may be substantially flush with a peak height of the convolutions on each of the comfort side and the support side. Preferably, the width of each of the side rails is about three inches.

In another exemplary embodiment, a reversible foam mattress is formed from a foam core. The foam core has a comfort side on one side, a support side on an opposite side, and side rails along longitudinal edges. Both the comfort side and the support side have convolutions across an entire area except for the side rails, where the convolutions on the comfort side are constructed to enhance comfort, and the convolutions on the support side are constructed to enhance support.

In yet another exemplary embodiment, a method of constructing a reversible foam mattress using a foam core includes the steps of (a) forming a first plurality of convolutions having a first height on one side of the foam core; and (b) forming a second plurality of convolutions having a second height side on an opposite side of the foam core, where the second height is shorter than the first height. Steps (a) and (b) are practiced such that at least longitudinal edges of the foam core are without convolutions to thereby define side rails along the longitudinal edges of the foam core.

### BRIEF DESCRIPTION OF THE DRAWINGS

These and other aspects and advantages of the invention will be described in detail with reference to the accompanying drawings, in which:

FIG. 1 is a perspective view of the reversible foam mattress;

FIG. 2 is a plan view thereof;

FIG. 3 is an end view showing the different height convolutions on each side of the mattress; and

FIG. 4 is a cross-sectional view of an alternative embodiment.

### DETAILED DESCRIPTION OF THE INVENTION

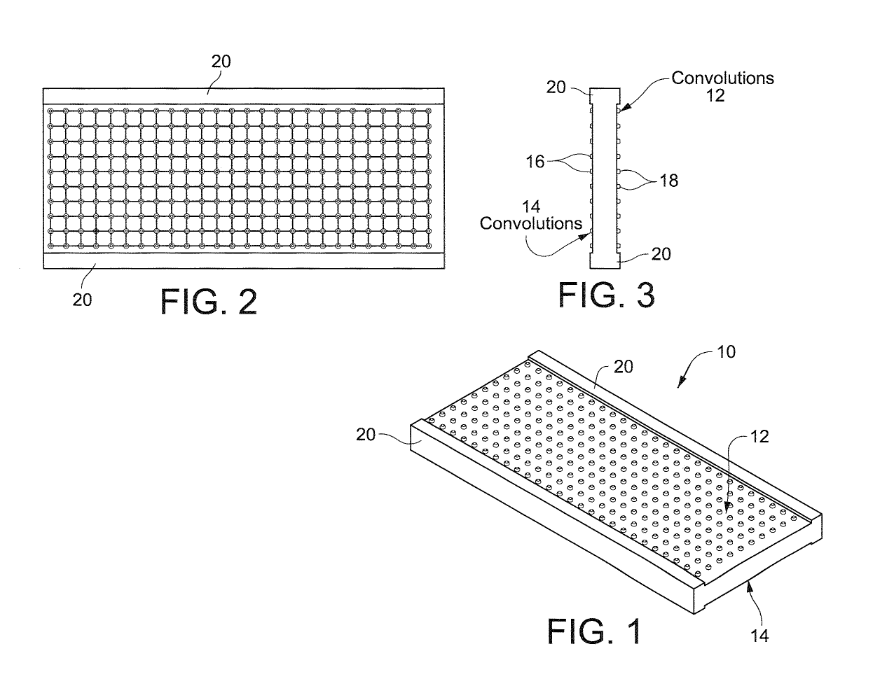

FIG. 1 is a perspective view of the reversible foam mattress according to preferred embodiments. The mattress is preferably formed of a single piece foam core 10. A preferred material for the foam core 10 is polyurethane foam. The foam core 10 is convoluted on both sides using a convolution tool. A convolution tool is known, and details of the use and operation thereof will not be described. The convolutions on one side of the foam core 10 are formed having a first height, defining a comfort side 12; and the convolutions on an opposite side of the foam core 10 are formed having a second height shorter than the first height, defining a support side 14 of the mattress.

As shown in FIG. 3, the short convolutions 16 allow for a more supportive surface on the support side 14, while the longer convolutions 18 allow for a more comfortable surface on the comfort side 12. The differently constructed sides 12, 14 permit the end consumer to decide which side of the foam core suits their needs in a support surface.

Preferably, the convolution height on the support side 14 is between 0.25-0.5 inches and is preferably about 0.45 inches. The convolution height on the comfort side 12 may be between 0.6-0.75 inches and is preferably about 0.65 inches. On the comfort side, a convolution lower than 0.60″ would feel much like the support side and would offer no distinction between the comfort and support sides. This same reasoning can be said for the support side convolute range. A preferred minimum difference between 0.50″ and 0.60″ allows for a distinct feeling of “comfort” or “support,” while not allowing the foam core to “bottom out” when a person lays on it.

As noted in the background discussion above, side rails are typically glued or otherwise laminated to longitudinal sides of a center foam piece. According to preferred embodiments, the foam core 10 is convoluted using a convolution tool that is narrower than the width of the foam core 10, thereby leaving end portions of the foam core 10 to define side rails 20. Preferably, the convolution tool is about six inches narrower than the width of the core such that each of the side rails 20 is about three inches in width.

As shown in the drawings, the convolutions cover substantially the entire top and bottom surfaces of the foam core 10 with the exception of the side rails 20. With reference to FIG. 3, the height of each side rail 20 is preferably substantially flush with a peak height of the convolutions 16, 18 on each side, respectively. The side rails provide a section for the end user to sit on either length edge of the mattress for prolonged periods without damaging or causing a dip to occur on the side rails 20.

Using a single piece foam core, the resulting mattress is constructed of a one-piece integral structure. The convoluted sides including different height convolutions allow the end user to decide which side of the foam core suits their needs in a support surface. Of course, the user has the ability to use one side or the other temporarily to accommodate a temporary medical condition. Additionally, with the described construction, the reversible mattress can be manufactured with fewer manufacturing steps, thereby saving manufacturing costs.

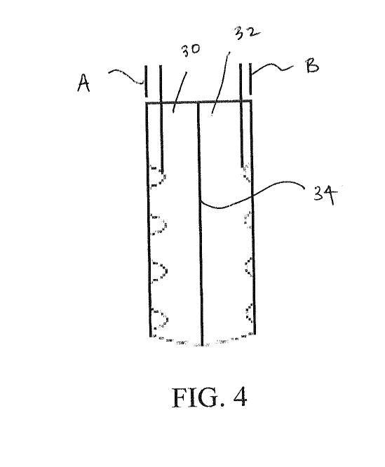

In an alternative construction shown in FIG. 4, the mattress can be formed using two foam cores 30, 32 glued or otherwise secured to form a combined foam core. For example, a 3″ foam core with convolutions of a first depth A may be joined with a 3″ foam core with convolutions of a second depth B to create a 6″ foam core mattress. The convolutions may be derived from the “Anatomic Convolute” product available from Anatomic Concepts of Corona, Calif. In an exemplary construction, depth A is about 1″ and depth B is about 0.5″. Preferably, the 3″ foam cores are secured via a glue seam 34 across the entire length and width of the non-convoluted sides of the foams 30, 32.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A reversible foam mattress formed of a foam core, the mattress comprising:
a comfort side on one side of the foam core;
a support side on an opposite side of the foam core; and
side rails formed along longitudinal edges of the foam core,
wherein the comfort side includes a first convoluted section with convolutions having a first height, and wherein the support side includes a second convoluted section with convolutions having a second height shorter than the first height.

2. A reversible foam mattress according to claim 1, wherein the first height is between 0.6 and 0.75 inches, and wherein the second height is between 0.25 and 0.5 inches.

3. A reversible foam mattress according to claim 1, wherein the first height is about 0.65 inches, and wherein the second height is about 0.45 inches.

4. A reversible foam mattress according to claim 1, wherein the side rails are integral with the foam core.

5. A reversible foam mattress according to claim 1, wherein the side rails comprise substantially flat surfaces across a width thereof.

6. A reversible foam mattress according to claim 5, wherein the flat surfaces are substantially flush with a peak height of the convolutions on each of the comfort side and the support side.

7. A reversible foam mattress according to claim 5, wherein the width of each of the side rails is about three inches.

8. A reversible foam mattress comprising a foam core, the foam core including a comfort side on one side of the foam core, a support side on an opposite side of the foam core, and side rails formed along longitudinal edges of the foam core, wherein the both the comfort side and the support side have convolutions across an entire area except for the side rails, and wherein the convolutions on the comfort side are constructed to enhance comfort, and the convolutions on the support side are constructed to enhance support.

9. A reversible foam mattress according to claim 8, wherein the convolutions on the comfort side are have a greater height than the convolutions on the support side.

10. A reversible foam mattress according to claim 9, wherein surfaces of the side rails that form part of the comfort side and the support side are substantially flush with a peak height of the convolutions on each of the comfort side and the support side.

11. A reversible foam mattress according to claim 9, the convolutions on the comfort side have a height of about 0.65 inches, and wherein convolutions on the support side have a height of about 0.45 inches.

12. A reversible foam mattress according to claim 9, wherein the foam core is a single piece foam core.

13. A reversible foam mattress according to claim 9, wherein the foam core is a two piece foam core.

14. A method of constructing a reversible foam mattress using a foam core, the method comprising:
(a) forming a first plurality of convolutions having a first height on one side of the foam core; and
(b) forming a second plurality of convolutions having a second height side on an opposite side of the foam core, wherein the second height is shorter than the first height,
wherein steps (a) and (b) are practiced such that at least longitudinal edges of the foam core are without convolutions to thereby define side rails along the longitudinal edges of the foam core.

15. A method according to claim 14, wherein steps (a) and (b) are practiced using a convolution tool.

16. A method according to claim 14, wherein steps (a) and (b) are practiced such that surfaces of the side rails that form part of the one side and the opposite side are substantially flush with a peak height of the convolutions on each of the one side and the opposite side.

17. A method according to claim 14, wherein steps (a) and (b) are practiced such that the side rails are each about three inches wide.

18. A method according to claim 14, wherein the foam core comprises a two piece foam core, and wherein the method further comprises gluing the foam core pieces via a glue seam across non-convoluted sides of the foam core pieces.

19. A reversible foam mattress constructed according to the method of claim 14.
